(19) United States
(12) Patent Application Publication
(10) Pub. No.: US 2015/0315381 A1
(43) Pub. Date: Nov. 5, 2015

(54) FLAME-RETARDANT POLYCARBONATE MOLDING MATERIALS I

(71) Applicant: Bayer MaterialScience AG, Leverkusen (DE)

(72) Inventors: Mathieu JUNG, Shanghai (CN); Thomas ECKEL, Dormagen (DE); Vera TASCHNER, Langenfeld (DE)

(21) Appl. No.: 14/649,047

(22) PCT Filed: Dec. 3, 2013
(86) PCT No.: PCT/EP2013/075314

§ 371 Date: Jun. 2, 2015

(30) Foreign Application Priority Data
Dec. 7, 2012 (EP) 12196049.6

(51) Int. Cl. C08L 69/00; C07F 9/659

(52) U.S. Cl. CPC C08L 69/00; C07F 9/659; C08L 2201/02; C08L 2205/03

(57) ABSTRACT

The present invention relates to flame-retardant, impact-modified polycarbonate (PC)/ABS compositions and moulding compositions which have high temperature stability and a high modulus of elasticity, good flowability and high hydrolytic stability.

The present application additionally relates to the use of the compositions in the production of moulded articles, and to moulded articles produced from the compositions.

The present invention relates to flame-retardant, impact-modified polycarbonate (PC)/acrylonitrile-butadiene-styrene (ABS) compositions having high temperature stability and comprising cyclic phosphazenes, which compositions have a high modulus of elasticity, good flowability, good notched impact strength and high hydrolytic stability, and also to processes for their production, and to the use of cyclic phosphazenes as flame retardants in polycarbonate compositions.

EP 1 095 099 A1 describes polycarbonate/ABS moulding compositions provided with phosphazenes and phosphorus compounds, which compositions have excellent flame retardancy and very good mechanical properties such as joint line strength or notched impact strength.

EP 1 196 498 A1 describes moulding compositions provided with phosphazenes and based on polycarbonate and graft polymers selected from the group of the silicone, EP(D)M and acrylate rubbers as graft base, which compositions have excellent flame retardancy and very good mechanical properties such as stress cracking resistance or notched impact strength.

EP 1 095 100 A1 describes polycarbonate/ABS moulding compositions comprising phosphazenes and inorganic nanoparticles, which compositions have excellent flame retardancy and very good mechanical properties.

EP 1 095 097 A1 describes polycarbonate/ABS moulding compositions provided with phosphazenes, which compositions have excellent flame retardancy and very good processing properties, wherein the graft polymer is produced by means of mass, solution or mass-suspension polymerisation processes.

US2003/040643 A1 describes a process for the preparation of phenoxyphosphazene, as well as polycarbonate/ABS moulding compositions comprising these phenoxyphosphazenes. The moulding compositions have good flame retardancy, good flowability, good impact strength and high heat distortion resistance.

In the above-mentioned documents, linear and cyclic phosphazenes are disclosed. In the case of the cyclic phosphazenes, the contents of trimers, tetramers and higher oligomers are not specified, however.

US2003/092802 A1 discloses phenoxyphosphazenes, as well as their preparation and use in polycarbonate/ABS moulding compositions. The phenoxyphosphazenes are preferably crosslinked, and the moulding compositions are distinguished by good flame retardancy, good impact strength, a high bending modulus and a high melt volume-flow rate. The ABS used is not described more precisely. Moreover, the contents of trimers, tetramers and higher oligomers of the present application are not described in this document.

JP 1995 0038462 describes polycarbonate compositions comprising graft polymers, phosphazenes as flame retardants and optionally vinyl copolymers. Specific structures, compositions and amounts of the flame retardant are not mentioned, however.

JP19990176718 describes thermoplastic compositions consisting of aromatic polycarbonate, copolymer of aromatic vinyl monomers and vinyl cyanides, graft polymer of alkyl (meth)acrylates and rubber, and phosphazene as flame retardant, which compositions have good flowability.

Accordingly, the object of the present invention is to provide a flame-retardant moulding composition which is distinguished by a property combination of good notched impact strength, temperature stability, modulus of elasticity, flowability and hydrolytic stability while having a consistently good UL94V0 classification at 1.5 mm.

The moulding compositions are preferably flame retardant and fulfil the requirements of UL94 with V-0 even at thin wall thicknesses (i.e. wall thickness of 1.5 mm).

It has been found, surprisingly, that the object of the present invention is achieved by compositions comprising
A) from 55 to 95 parts by weight, preferably from 65 to 90 parts by weight, more preferably from 70 to 85 parts by weight, particularly preferably from 76 to 88 parts by weight, of aromatic polycarbonate and/or aromatic polyester carbonate,
B) from 1.0 to 20.0 parts by weight, preferably from 3.0 to 18.0 parts by weight, particularly preferably from 7.0 to 15.0 parts by weight, of rubber-modified graft polymer comprising
   B1) optionally at least one graft polymer prepared by the emulsion polymerisation process, and
   B2) at least one graft polymer prepared by the mass, suspension or solution polymerisation process,
   wherein B2) is present in an amount of at least 50 wt. %, based on component B,
C) from 1.0 to 20.0 parts by weight, preferably from 4.5 to 18.0 parts by weight, more preferably from 6.0 to 15.0 parts by weight, particularly preferably from 8.5 to 12.0 parts by weight, of at least one cyclic phosphazene of structure (X)

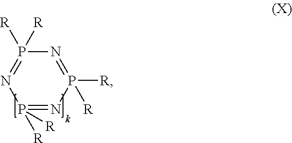

wherein
k represents 1 or an integer from 1 to 10, preferably a number from 1 to 8, particularly preferably from 1 to 5,
   having a trimer content (k=1) of from 60 to 98 mol %, more preferably from 65 to 95 mol %, particularly preferably from 65 to 90 mol %, and most particularly preferably from 65 to 85 mol %, in particular from 70 to 85 mol %, based on component C,
and wherein
R is in each case identical or different and represents an amine radical; C₁- to C₈-alkyl, preferably methyl, ethyl, propyl or butyl, each optionally halogenated, preferably halogenated with fluorine; C₁- to C₈-alkoxy, preferably methoxy, ethoxy, propoxy or butoxy; C₅- to C₆-cycloalkyl each optionally substituted by alkyl, preferably C₁-C₄-alkyl, and/or by halogen, preferably chlorine and/or bromine; C₆- to C₂₀-aryloxy, preferably phenoxy, naphthyloxy, each optionally substituted by alkyl, preferably C₁-C₄-alkyl, and/or by halogen, preferably chlorine, bromine, and/or by hydroxy; C₇- to C₁₂-aralkyl, preferably phenyl-C₁-C₄-alkyl, each optionally substituted by alkyl, preferably C₁-C₄-alkyl, and/or by halogen, preferably chlorine and/or bromine; or a halogen radical, preferably chlorine; or an OH radical,
D) from 0 to 15.0 parts by weight, preferably from 2.0 to 12.5 parts by weight, more preferably from 3.0 to 9.0 parts by weight, particularly preferably from 3.0 to 6.0 parts by weight, of rubber-free vinyl (co)polymer or polyalkylene terephthalate,
E) from 0 to 15.0 parts by weight, preferably from 0.05 to 15.00 parts by weight, more preferably from 0.2 to 10.0 parts by weight, particularly preferably from 0.4 to 5.0 parts by weight, of additives,
F) from 0.05 to 5.00 parts by weight, preferably from 0.1 to 2.0 parts by weight, particularly preferably from 0.1 to 1.0 part by weight, of antidripping agents,
   wherein all parts by weight are preferably so normalised in the present application that the sum of the parts by weight of all the components A+B+C+D+E+F in the composition is 100.

In a preferred embodiment, the composition consists only of components A to F.

In a preferred embodiment, the composition is free of inorganic flame retardants and flame-retardant synergists, in particular aluminium hydroxide, aluminium oxide hydroxide and arsenic and antimony oxides.

In a preferred embodiment, the composition is free of further organic flame retardants, in particular bisphenol A diphosphate oligomers, resorcinol diphosphate oligomers, triphenyl phosphate, octamethyl-resorcinol diphosphate and tetrabromo-bisphenol A diphosphate oligocarbonate.

The preferred embodiments can be carried out individually or in combination with one another.

The invention likewise provides processes for the production of the moulding compositions, and the use of the moulding compositions in the production of moulded articles, and the use of cyclic phosphazenes with a defined oligomer distribution in the production of the compositions according to the invention.

The moulding compositions according to the invention can be used in the production of moulded articles of any kind. These can be produced by injection moulding, extrusion and blow moulding processes. A further form of processing is the production of moulded articles by deep drawing from previously produced sheets or films.

Examples of such moulded articles are films, profiles, casing parts of any kind, for example for domestic appliances such as juice extractors, coffee machines, mixers; for office machines such as monitors, flat screens, notebooks, printers, copiers; sheets, tubes, conduits for electrical installations, windows, doors and further profiles for the construction sector (interior fitting and external applications) as well as parts for electronics and electrical engineering, such as switches, plugs and sockets, as well as bodywork and interior components for commercial vehicles, in particular for the automotive sector.

In particular, the moulding compositions according to the invention can also be used, for example, in the production of the following moulded articles or mouldings: Parts for the interior finishing of railway vehicles, ships, aircraft, buses and other motor vehicles, casings for electrical devices containing small transformers, casings for devices for processing and transmitting information, casings and coverings for medical devices, casings for security devices, mouldings for sanitary and bathroom fittings, cover grids for ventilator openings, and casings for garden equipment.

### Component A

Aromatic polycarbonates and/or aromatic polyester carbonates according to component A that are suitable according to the invention are known in the literature or can be prepared by processes known in the literature (for the preparation of aromatic polycarbonates see, for example, Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the preparation of aromatic polyester carbonates see e.g. DE-A 3 007 934).

The preparation of aromatic polycarbonates is carried out, for example, by reaction of diphenols with carbonic acid halides, preferably phosgene, and/or with aromatic dicarboxylic acid dihalides, preferably benzenedicarboxylic acid dihalides, according to the interfacial process, optionally using chain terminators, for example monophenols, and optionally using branching agents having a functionality of three or more than three, for example triphenols or tetraphenols. Preparation by a melt polymerisation process by reaction of diphenols with, for example, diphenyl carbonate is also possible.

Diphenols for the preparation of the aromatic polycarbonates and/or aromatic polyester carbonates are preferably those of formula (I)

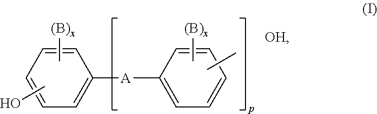

wherein
A is a single bond, C₁- to C₅-alkylene, C₂- to C₅-alkylidene, C₅- to C₆-cyclo-alkylidene, —O—, —SO—, —CO—, —S—, —SO₂—, C₆- to C₁₂-arylene, to which further aromatic rings optionally containing heteroatoms can be fused, or a radical of formula (II) or (III)

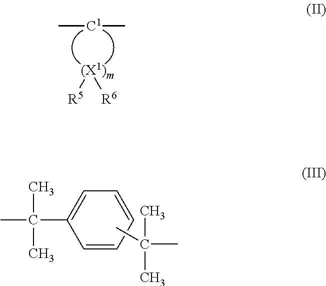

B is in each case C₁- to C₁₂-alkyl, preferably methyl, halogen, preferably chlorine and/or bromine,
x each independently of the other is 0, 1 or 2,
p is 1 or 0, and
R⁵ and R⁶ can be chosen individually for each X¹ and each independently of the other is hydrogen or C₁- to C₆-alkyl, preferably hydrogen, methyl or ethyl,
X¹ is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxyphenyl) sulfoxides, bis-(hydroxyphenyl) ketones, bis-(hydroxyphenyl)-sulfones and α,α-bis-(hydroxyphenyl)-diisopropyl-benzenes, and derivatives thereof brominated and/or chlorinated on the ring.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone and di- and tetra-brominated or chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. 2,2-Bis-(4-hydroxyphenyl)-propane (bisphenol A) is particularly preferred. The diphenols can be used on their own or in the form of arbitrary mixtures. The diphenols are known in the literature or are obtainable according to processes known in the literature.

Chain terminators suitable for the preparation of thermoplastic aromatic polycarbonates are, for example, phenol, p-chlorophenol, p-tert-butylphenol or 2,4,6-tribromophenol, but also long-chained alkylphenols, such as 4-[2-(2,4,4-trimethylpentyl)]-phenol, 4-(1,3-tetramethylbutyl)-phenol according to DE-A 2 842 005 or monoalkylphenol or dialkylphenols having a total of from 8 to 20 carbon atoms in the alkyl substituents, such as 3,5-di-tert-butylphenol, p-isooctylphenol, p-tert-octylphenol, p-dodecylphenol and 2-(3,5-dimethylheptyl)-phenol and 4-(3,5-dimethylheptyl)-phenol. The amount of chain terminators to be used is generally from 0.5 mol % to 10 mol %, based on the molar sum of the diphenols used in a particular case.

The thermoplastic aromatic polycarbonates have mean molecular weights (weight-average M_{w}, measured by GPC (gel permeation chromatography) with polycarbonate standard) of from 15,000 to 80,000 g/mol, preferably from 19,000 to 32,000 g/mol, particularly preferably from 22,000 to 30,000 g/mol.

The thermoplastic aromatic polycarbonates can be branched in a known manner, preferably by the incorporation of from 0.05 to 2.0 mol %, based on the sum of the diphenols used, of compounds having a functionality of three or more than three, for example those having three or more phenolic groups. Preference is given to the use of linear polycarbonates, more preferably based on bisphenol A.

Both homopolycarbonates and copolycarbonates are suitable. For the preparation of copolycarbonates of component A according to the invention it is also possible to use from 1 to 25 wt. %, preferably from 2.5 to 25 wt. %, based on the total amount of diphenols to be used, of polydiorganosiloxanes having hydroxyaryloxy end groups. These are known (U.S. Pat. No. 3,419,634) and can be prepared according to processes known in the literature. Also suitable are copolycarbonates containing polydiorganosiloxanes; the preparation of copolycarbonates containing polydiorganosiloxanes is described, for example, in DE-A 3 334 782.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Mixtures of the diacid dichlorides of isophthalic acid and terephthalic acid in a ratio of from 1:20 to 20:1 are particularly preferred.

In the preparation of polyester carbonates, a carbonic acid halide, preferably phosgene, is additionally used concomitantly as bifunctional acid derivative.

Suitable chain terminators for the preparation of the aromatic polyester carbonates, in addition to the monophenols already mentioned, are also the chlorocarbonic acid esters thereof and the acid chlorides of aromatic monocarboxylic acids, which can optionally be substituted by C₁- to C₂₂-alkyl groups or by halogen atoms, as well as aliphatic C₂- to C₂₂-monocarboxylic acid chlorides.

The amount of chain terminators is in each case from 0.1 to 10 mol %, based in the case of phenolic chain terminators on mol of diphenol and in the case of monocarboxylic acid chloride chain terminators on mol of dicarboxylic acid dichloride.

One or more aromatic hydroxycarboxylic acids can additionally be used in the preparation of aromatic polyester carbonates.

The aromatic polyester carbonates can be both linear and branched in known manner (see in this connection DE-A 2 940 024 and DE-A 3 007 934), linear polyester carbonates being preferred.

There can be used as branching agents, for example, carboxylic acid chlorides having a functionality of three or more, such as trimesic acid trichloride, cyanuric acid trichloride, 3,3′-,4,4′-benzophenone-tetracarboxylic acid tetrachloride, 1,4,5,8-naphthalenetetracarboxylic acid tetrachloride or pyromellitic acid tetrachloride, in amounts of from 0.01 to 1.0 mol % (based on dicarboxylic acid dichlorides used), or phenols having a functionality of three or more, such as phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytriphenyl)-methyl]-benzene, in amounts of from 0.01 to 1.0 mol %, based on diphenols used. Phenolic branching agents can be placed in a vessel with the diphenols; acid chloride branching agents can be introduced together with the acid dichlorides.

The content of carbonate structural units in the thermoplastic aromatic polyester carbonates can vary as desired. The content of carbonate groups is preferably up to 100 mol %, in particular up to 80 mol %, particularly preferably up to 50 mol %, based on the sum of ester groups and carbonate groups. Both the esters and the carbonates contained in the aromatic polyester carbonates can be present in the polycondensation product in the form of blocks or distributed randomly.

The thermoplastic aromatic polycarbonates and polyester carbonates can be used on their own or in an arbitrary mixture.

### Component B

Component B comprises components B1 and B2 preferably in the following amounts:
B1: from 0 to 50 wt. %, preferably from 10 to 45 wt. %, particularly preferably from 10 to 30 wt. %;
B2: from 50 to 100 wt. %, preferably from 55 to 90 wt. %, particularly preferably from 70 to 90 wt. %;
   in each case based on component B.

### Component B1

Component B1 is graft polymers, prepared by the emulsion polymerisation process, of, in a preferred embodiment,

B1.1) from 5 to 95 wt. %, preferably from 10 to 70 wt. %, particularly preferably from 20 to 60 wt. %, based on component B1, of a mixture of
B1.1.1) from 65 to 85 wt. %, preferably from 70 to 80 wt. %, based on B1.1, of at least one monomer selected from the group of the vinyl aromatic compounds (such as, for example, styrene, α-methylstyrene), vinyl aromatic compounds substituted on the ring (such as, for example, p-methylstyrene, p-chlorostyrene) and methacrylic acid (C1-C8)-alkyl esters (such as, for example, methyl methacrylate, ethyl methacrylate) and
B1.1.2) from 15 to 35 wt. %, preferably from 20 to 30 wt. %, based on B1.1, of at least one monomer selected from the group of the vinyl cyanides (such as, for example, unsaturated nitriles such as acrylonitrile and methacrylonitrile), (meth)acrylic acid (C1-C8)-alkyl esters (such as, for example, methyl methacrylate, n-butyl acrylate, tert-butyl acrylate) and derivatives (such as, for example, anhydrides and imides) of unsaturated carboxylic acids (for example maleic anhydride and N-phenyl-maleimide)
on
B1.2) from 95 to 5 wt. %, preferably from 90 to 30 wt. %, particularly preferably from 80 to 40 wt. %, based on component B1, of at least one elastomeric graft base.

The graft base has a glass transition temperature of preferably <0° C., more preferably <−20° C., particularly preferably <−60° C.

Unless indicated otherwise in the present invention, glass transition temperatures are determined by means of differential scanning calorimetry (DSC) according to standard DIN EN 61006 at a heating rate of 10 K/min with definition of the Tg as the mid-point temperature (tangent method) and nitrogen as protecting gas.

The graft particles in component B1 preferably have a mean particle size (d₅₀ value) of from 0.05 to 5 μm, preferably from 0.1 to 1.0 μm, particularly preferably from 0.2 to 0.5 μm.

The mean particle size d₅₀ is the diameter above and below which in each case 50 wt. % of the particles lie. It can be determined, unless explicitly indicated otherwise in the present application, by means of ultracentrifuge measurement (W. Scholtan, H. Lange, Kolloid, Z. and Z. Polymere 250 (1972), 782-1796).

Preferred monomers B1.1.1 are selected from at least one of the monomers styrene, a-methylstyrene and methyl methacrylate; preferred monomers B1.1.2 are selected from at least one of the monomers acrylonitrile, maleic anhydride and methyl methacrylate.

Particularly preferred monomers are B1.1.1 styrene and B1.1.2 acrylonitrile.

Graft bases B1.2 suitable for the graft polymers B1 are, for example, diene rubbers, diene-vinyl block copolymer rubbers, EP(D)M rubbers, that is to say those based on ethylene/propylene and optionally diene, acrylate, polyurethane, silicone, chloroprene and ethylene/vinyl acetate rubbers as well as mixtures of such rubbers, or silicone-acrylate composite rubbers in which the silicone and the acrylate components are linked together chemically (e.g. by grafting).

Preferred graft bases B1.2 are diene rubbers (e.g. based on butadiene or isoprene), diene-vinyl block copolymer rubbers (e.g. based on butadiene and styrene blocks), copolymers of diene rubbers with further copolymerisable monomers (e.g. according to B1.1.1 and B1.1.2) and mixtures of the types of rubber mentioned above. Pure polybutadiene rubber and styrene-butadiene block copolymer rubber are particularly preferred.

The gel content of the graft polymers is at least 40 wt. %, preferably at least 60 wt. %, particularly preferably at least 75 wt. % (measured in acetone).

Unless indicated otherwise in the present invention, the gel content of the graft polymers is determined at 25° C. as the fraction that is insoluble in acetone as solvent (M. Hoffmann, H. Krömer, R. Kuhn, Polymeranalytik I and II, Georg Thieme-Verlag, Stuttgart 1977).

The graft polymers B1 are prepared by radical polymerisation.

The graft polymer B1 generally comprises, as a result of its preparation, free copolymer of B1.1.1 and B1.1.2, that is to say copolymer that is not chemically bonded to the rubber base, which is distinguished by the fact that it can be dissolved in suitable solvents (e.g. acetone).

Component B1 preferably comprises a free copolymer of B1.1.1 and B1.1.2 which has a weight-average molecular weight (Mw), determined by gel permeation chromatography with polystyrene as standard, of preferably from 30,000 to 150,000 g/mol, particularly preferably from 40,000 to 120,000 g/mol.

### Component B2

The compositions according to the invention can optionally comprise as component B2 graft polymers prepared by the mass, solution or suspension polymerisation process. In a preferred embodiment, they are graft polymers of

B2.1) from 5 to 95 wt. %, preferably from 80 to 93 wt. %, particularly preferably from 85 to 92 wt. %, most particularly preferably from 87 to 93 wt. %, based on component B2, of a mixture of
B2.1.1) from 65 to 85 wt. %, preferably from 70 to 80 wt. %, based on the mixture B2.1, of at least one monomer selected from the group of the vinyl aromatic compounds (such as, for example, styrene, a-methylstyrene), vinyl aromatic compounds substituted on the ring (such as, for example, p-methylstyrene, p-chlorostyrene) and methacrylic acid (C1-C8)-alkyl esters (such as, for example, methyl methacrylate, ethyl methacrylate) and
B2.1.2) from 15 to 35 wt. %, preferably from 20 to 30 wt. %, based on the mixture B2.1, of at least one monomer selected from the group of the vinyl cyanides (such as, for example, unsaturated nitriles such as acrylonitrile and methacrylonitrile), (meth)acrylic acid (C1-C8)-alkyl esters (such as, for example, methyl methacrylate, n-butyl acrylate, tert-butyl acrylate) and derivatives (such as, for example, anhydrides and imides) of unsaturated carboxylic acids (for example maleic anhydride and N-phenyl-maleimide)
on
B2.2) from 95 to 5 wt. %, preferably from 20 to 7 wt. %, particularly preferably from 15 to 8 wt. %, most particularly preferably from 13 to 7 wt. %, based on component B2,
of at least one graft base.

The graft base has a glass transition temperature of preferably <0° C., more preferably <−20° C., particularly preferably <−60° C.

The graft particles in component B2 preferably have a mean particle size (d₅₀ value) of from 0.1 to 10 μm, preferably from 0.2 to 2 μm, particularly preferably from 0.3 to 1.0 μm, most particularly preferably from 0.3 to 0.6 μm.

Preferred monomers B2.1.1 are selected from at least one of the monomers styrene, a-methylstyrene and methyl methacrylate; preferred monomers B2.1.2 are selected from at least one of the monomers acrylonitrile, maleic anhydride and methyl methacrylate.

Particularly preferred monomers are B2.1.1 styrene and B2.1.2 acrylonitrile.

Graft bases B2.2 suitable for the graft polymers B2 are, for example, diene rubbers, diene-vinyl block copolymer rubbers, EP(D)M rubbers, that is to say those based on ethylene/propylene and mixtures of such rubbers.

Preferred graft bases B2.2 are diene rubbers (e.g. based on butadiene or isoprene), diene-vinyl block copolymer rubbers (e.g. based on butadiene and styrene blocks), copolymers of diene rubbers with further copolymerisable monomers (e.g. according to B2.1.1 and B2.1.2) and mixtures of the types of rubber mentioned above. Styrene-butadiene block copolymer rubbers and mixtures of styrene-butadiene block copolymer rubbers with pure polybutadiene rubber are particularly preferred as the graft base B2.2.

The gel content of the graft polymers B2 is preferably from 10 to 35 wt. %, particularly preferably from 15 to 30 wt. %, most particularly preferably from 17 to 23 wt. % (measured in acetone).

Particularly preferred polymers B2 are, for example, ABS polymers prepared by radical polymerisation, which in a preferred embodiment comprise up to 10 wt. %, particularly preferably up to 5 wt. %, particularly preferably from 2 to 5 wt. %, in each case based on the graft polymer B2, of n-butyl acrylate.

The graft polymer B2 generally comprises, as a result of its preparation, free copolymer of B2.1.1 and B2.1.2, that is to say copolymer that is not chemically bonded to the rubber base, which is distinguished by the fact that it can be dissolved in suitable solvents (e.g. acetone).

Component B2 preferably comprises free copolymer of B2.1.1 and B2.1.2 which has a weight-average molecular weight (Mw), determined by gel permeation chromatography with polystyrene as standard, of preferably from 50,000 to 200,000 g/mol, particularly preferably from 70,000 to 150,000 g/mol, particularly preferably from 80,000 to 120,000 g/mol.

### Component C

Phosphazenes according to component C which are used according to the present invention are cyclic phosphazenes according to formula (X)

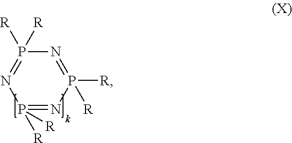

wherein
R is in each case identical or different and represents
   an amine radical,
   C₁- to C₈-alkyl, preferably methyl, ethyl, propyl or butyl, each optionally halogenated, preferably halogenated with fluorine, more preferably monohalogenated,
   C₁- to C₈-alkoxy, preferably methoxy, ethoxy, propoxy or butoxy,
   C₅- to C₆-cycloalkyl each optionally substituted by alkyl, preferably C₁-C₄-alkyl, and/or by halogen, preferably chlorine and/or bromine,
   C₆- to C₂₀-aryloxy, preferably phenoxy, naphthyloxy, each optionally substituted by alkyl, preferably C₁-C₄-alkyl, and/or by halogen, preferably chlorine, bromine, and/or by hydroxy,
   C₇- to C₁₂-aralkyl, preferably phenyl-C₁-C₄-alkyl, each optionally substituted by alkyl, preferably C₁-C₄-alkyl, and/or by halogen, preferably chlorine and/or bromine, or
   a halogen radical, preferably chlorine or fluorine, or
   an OH radical,
k has the meaning mentioned above.

Preference is given to:

propoxyphosphazene, phenoxyphosphazene, methylphenoxyphosphazene, aminophosphazene and fluoroalkylphosphazenes, as well as phosphazenes having the following structures:

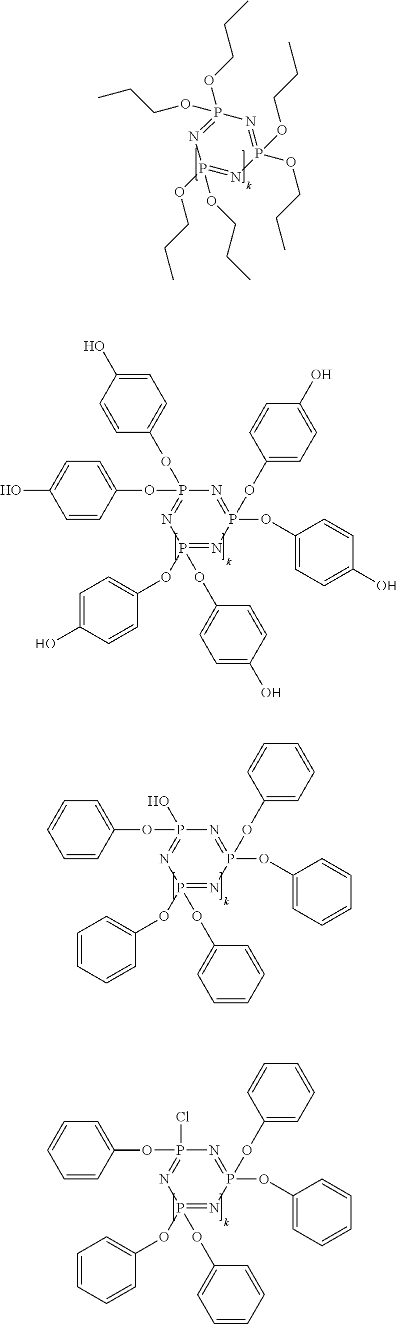

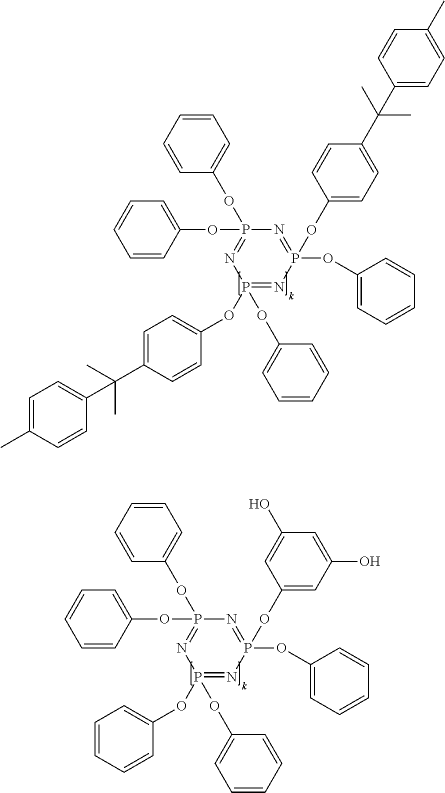

In the compounds shown above, k=1, 2 or 3.

Preference is given to phenoxyphosphazene (all R=phenoxy) having a content of oligomers with k=1 (C1) of from 60 to 98 mol %.

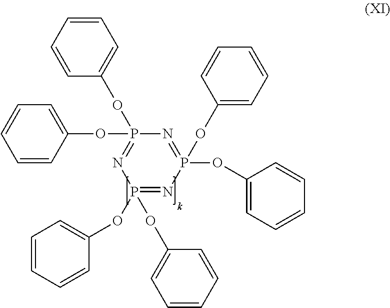

In the case where the phosphazene according to formula (X) is halo-substituted on the phosphorus, for example from incompletely reacted starting material, the content of this phosphazene halo-substituted on the phosphorus is preferably less than 1000 ppm, more preferably less than 500 ppm.

The phosphazenes can be used on their own or in the form of a mixture, that is to say the radical R can be identical or two or more radicals in formula (X) can be different. The radicals R of a phosphazene are preferably identical.

In a further preferred embodiment, only phosphazenes with identical R are used.

In a preferred embodiment, the content of tetramers (k=2) (C2) is from 2 to 50 mol %, based on component C, more preferably from 5 to 40 mol %, yet more preferably from 10 to 30 mol %, particularly preferably from 10 to 20 mol %.

In a preferred embodiment, the content of higher oligomeric phosphazenes (k=3, 4, 5, 6 and 7) (C3) is from 0 to 30 mol %, based on component C, more preferably from 2.5 to 25 mol %, yet more preferably from 5 to 20 mol % and particularly preferably from 6 to 15 mol %.

In a preferred embodiment, the content of oligomers with k>=8 (C4) is from 0 to 2.0 mol %, based on component C, and preferably from 0.10 to 1.00 mol %.

In a further preferred embodiment, the phosphazenes of component C fulfil all three conditions mentioned above as regards the contents (C2-C4).

Component C is preferably a phenoxyphosphazene with a trimer content (k=1) of from 65 to 85 mol %, a tetramer content (k=2) of from 10 to 20 mol %, a content of higher oligomeric phosphazenes (k=3, 4, 5, 6 and 7) of from 5 to 20 mol % and of phosphazene oligomers with k>=8 of from 0 to 2 mol %, based on component C.

Component C is particularly preferably a phenoxyphosphazene with a trimer content (k=1) of from 70 to 85 mol %, a tetramer content (k=2) of from 10 to 20 mol %, a content of higher oligomeric phosphazenes (k=3, 4, 5, 6 and 7) of from 6 to 15 mol % and of phosphazene oligomers with k>=8 of from 0.1 to 1 mol %, based on component C.

In a further particularly preferred embodiment, component C is a phenoxyphosphazene with a trimer content (k=1) of from 65 to 85 mol %, a tetramer content (k=2) of from 10 to 20 mol %, a content of higher oligomeric phosphazenes (k=3, 4, 5, 6 and 7) of from 5 to 15 mol % and of phosphazene oligomers with k>=8 of from 0 to 1 mol %, based on component C.

n defines the weighted arithmetic mean of k according to the following formula:

$$n = \frac{{Σ}_{i = 1}^{max} ki \cdot xi}{{Σ}_{i = 1}^{max} xi}$$

where xᵢ is the content of the oligomer kᵢ, and the sum of all xᵢ is accordingly 1.

In an alternative embodiment, n is in the range from 1.10 to 1.75, preferably from 1.15 to 1.50, more preferably from 1.20 to 1.45, and particularly preferably from 1.20 to 1.40 (including the limits of the ranges).

The phosphazenes and their preparation are described, for example, in EP-A 728 811, DE-A 1 961668 and WO 97/40092.

The oligomer compositions of the phosphazenes in the blend samples can also be detected and quantified, after compounding, by means of ³¹P NMR (chemical shift; δ trimer: 6.5 to 10.0 ppm; δ tetramer: −10 to −13.5 ppm; δ higher oligomers: −16.5 to −25.0 ppm).

### Component D

Component D comprises one or more thermoplastic vinyl (co)polymers or polyalkylene terephthalates.

Suitable as vinyl (co)polymers D are polymers of at least one monomer from the group of the vinyl aromatic compounds, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. Particularly suitable are (co)polymers of
D.1 from 50 to 99 parts by weight, preferably from 60 to 80 parts by weight, of vinyl aromatic compounds and/or vinyl aromatic compounds substituted on the ring (such as styrene, a-methylstyrene, p-methylstyrene, p-chlorostyrene) and/or (meth)acrylic acid (C₁-C₈)-alkyl esters (such as methyl methacrylate, ethyl methacrylate), and
D.2 from 1 to 50 parts by weight, preferably from 20 to 40 parts by weight, of vinyl cyanides (unsaturated nitriles), such as acrylonitrile and methacrylonitrile, and/or (meth)acrylic acid (C₁-C₈)-alkyl esters, such as methyl methacrylate, n-butyl acrylate, tert-butyl acrylate, and/or unsaturated carboxylic acids, such as maleic acid, and/or derivatives, such as anhydrides and imides, of unsaturated carboxylic acids (for example maleic anhydride and N-phenylmaleimide).

The vinyl (co)polymers D are resin-like, thermoplastic and rubber-free. Particular preference is given to the copolymer of D.1 styrene and D.2 acrylonitrile.

The (co)polymers according to D are known and can be prepared by radical polymerisation, in particular by emulsion, suspension, solution or mass polymerisation. The (co)polymers preferably have mean molecular weights Mw (weight-average, determined by light scattering or sedimentation) of from 15,000 to 200,000 g/mol, particularly preferably from 100,000 to 150,000 g/mol.

In a particularly preferred embodiment, D is a copolymer of 77 wt. % styrene and 23 wt. % acrylonitrile with a weight-average molecular weight M_{w} of 130,000 g/mol.

Suitable as component D the compositions comprise according to the invention one or a mixture of two or more different polyalkylene terephthalates.

Polyalkylene terephthalates within the scope of the invention are polyalkylene terephthalates which are derived from terephthalic acid (or reactive derivatives, e.g. dimethyl esters or anhydrides, thereof) and alkanediols, cycloaliphatic or araliphatic diols and mixtures thereof, for example based on propylene glycol, butanediol, pentanediol, hexanediol, 1,2-cyclohexanediol, 1,4-cyclohexanediol, 1,3-cyclohexanediol and cyclohexyldimethanol, wherein the diol component according to the invention contains more than 2 carbon atoms. Accordingly, there are used as component D preferably polybutylene terephthalate and/or polytrimethylene terephthalate, most preferably polybutylene terephthalate.

The polyalkylene terephthalates according to the invention can comprise as the monomer of the diacid also up to 5 wt. % isophthalic acid.

Preferred polyalkylene terephthalates can be prepared by known methods from terephthalic acid (or reactive derivatives thereof) and aliphatic or cycloaliphatic diols having from 3 to 21 carbon atoms (Kunststoff-Handbuch, Vol. VIII, p. 695 ff, Karl-Hanser-Verlag, Munich 1973).

Preferred polyalkylene terephthalates comprise at least 80 mol %, preferably at least 90 mol %, based on the diol component, 1,3-propanediol and/or 1,4-butanediol radicals.

As well as comprising terephthalic acid radicals, the preferred polyalkylene terephthalates can comprise up to 20 mol % of radicals of other aromatic dicarboxylic acids having from 8 to 14 carbon atoms or of aliphatic dicarboxylic acids having from 4 to 12 carbon atoms, such as radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid.

As well as comprising 1,3-propanediol or 1,4-butanediol radicals, the preferred polyalkylene terephthalates can comprise up to 20 mol % of other aliphatic diols having from 3 to 12 carbon atoms or cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, cyclohexane-1,4-dimethanol, 3-methyl-2,4-pentanediol, 2-methyl-2,4-pentanediol, 2,2,4-trimethyl-1,3-pentanediol and 2-ethyl-1,6-hexanediol, 2,2-diethyl-1,3-propanediol, 2,5-hexanediol, 1,4-di-(β-hydroxyethoxy)-benzene, 2,2-bis-(4-hydroxycyclohexyl)-propane, 2,4-dihydroxy-1,1,3,3-tetra-methyl-cyclobutane, 2,2-bis-(3-β-hydroxyethoxyphenyl)-propane and 2,2-bis-(4-hydroxypropoxy-phenyl)-propane (DE-A 24 07 674, 24 07 776, 27 15 932).

The polyalkylene terephthalates can be branched by incorporation of relatively small amounts of tri- or tetra-hydric alcohols or tri- or tetra-basic carboxylic acids, as are described, for example, in DE-A 19 00 270 and US-A 3 692 744. Examples of preferred branching agents are trimesic acid, trimellitic acid, trimethylol-ethane and -propane and pentaerythritol.

It is advisable to use not more than 1 mol % of the branching agent, based on the acid component.

Particular preference is given to polyalkylene terephthalates that have been prepared solely from terephthalic acid or reactive derivatives thereof (e.g. dialkyl esters thereof, such as dimethyl terephthalate) and 1,3-propanediol and/or 1,4-butanediol (polypropylene and polybutylene terephthalate) and mixtures of such polyalkylene terephthalates.

Preferred polyalkylene terephthalates are also copolyesters prepared from at least two of the above-mentioned acid components and/or from at least two of the above-mentioned alcohol components, particularly preferred copolyesters are poly-(1,3-propylene glycol/1,4-butanediol) terephthalates.

The polyalkylene terephthalates generally have an intrinsic viscosity of approximately from 0.4 to 1.5 dl/g, preferably from 0.5 to 1.3 dl/g, in each case measured in phenol/o-dichlorobenzene (1:1 parts by weight) at 25° C.

In an alternative embodiment, the polyesters prepared according to the invention can also be used in admixture with other polyesters and/or further polymers, preference being given here to the use of mixtures of polyalkylene terephthalates with other polyesters.

### Further Additives E

The composition can comprise further conventional polymer additives, such as flame-retardant synergists other than antidripping agents, lubricants and demoulding agents (for example pentaerythritol tetrastearate), nucleating agents, stabilisers (for example UV/light stabilisers, heat stabilisers, antioxidants, transesterification inhibitors, hydrolytic stabilisers), antistatics (for example conductive blacks, carbon fibres, carbon nanotubes as well as organic antistatics such as polyalkylene ethers, alkyl sulfonates or polyamide-containing polymers) as well as colourants, pigments, fillers and reinforcing materials, in particular glass fibres, mineral reinforcing materials and carbon fibres.

There are preferably used as stabilisers sterically hindered phenols and phosphites or mixtures thereof, such as, for example, Irganox® B900 (Ciba Speciality Chemicals). Pentaerythritol tetrastearate is preferably used as the demoulding agent. Carbon black is further preferably used as a black pigment (e.g. Blackpearls).

As well as comprising optional further additives, particularly preferred moulding compositions comprise as component E a demoulding agent, particularly preferably pentaerythritol tetrastearate, in an amount of from 0.1 to 1.5 parts by weight, preferably from 0.2 to 1.0 part by weight, particularly preferably from 0.3 to 0.8 part by weight.

As well as comprising optional further additives, particularly preferred moulding compositions comprise as component E at least one stabiliser, for example selected from the group of the sterically hindered phenols, phosphites and mixtures thereof and particularly preferably Irganox® B900, in an amount of from 0.01 to 0.5 part by weight, preferably from 0.03 to 0.4 part by weight, particularly preferably from 0.06 to 0.3 part by weight.

The combination of PTFE (component F), pentaerythritol tetrastearate and Irganox B900 with a phosphorus-based flame retardant as component C) is also particularly preferred.

### Component F

There are used as antidripping agents in particular polytetrafluoroethylene (PTFE) or PTFE-containing compositions such as, for example, masterbatches of PTFE with styrene- or methyl-methacrylate-containing polymers or copolymers, in the form of powders or in the form of a coagulated mixture, for example with component B.

The fluorinated polyolefins used as antidripping agents have a high molecular weight and have glass transition temperatures of over −30° C., generally over 100° C., fluorine contents of preferably from 65 to 76 wt. %, in particular from 70 to 76 wt. %, mean particle diameters d₅₀ of from 0.05 to 1000 μm, preferably from 0.08 to 20 μm. In general, the fluorinated polyolefins have a density of from 1.2 to 2.3 g/cm³. Preferred fluorinated polyolefins are polytetrafluoroethylene, polyvinylidene fluoride, tetrafluoroethylene/hexafluoropropylene and ethylene/tetrafluoroethylene copolymers. The fluorinated polyolefins are known (see “Vinyl and Related Polymers” by Schildknecht, John Wiley & Sons, Inc., New York, 1962, pages 484-494; “Fluorpolymers” by Wall, Wiley-Interscience, John Wiley & Sons, Inc., New York, Volume 13, 1970, pages 623-654; “Modern Plastics Encyclopedia”, 1970-1971, Volume 47, No. 10 A, October 1970, McGraw-Hill, Inc., New York, pages 134 and 774; “Modern Plastics Encyclopedia”, 1975-1976, October 1975, Volume 52, No. 10 A, McGraw-Hill, Inc., New York, pages 27, 28 and 472 and US-PS 3 671 487, 3 723 373 and 3 838 092).

They can be prepared by known processes, for example by polymerisation of tetrafluoroethylene in an aqueous medium with a free-radical-forming catalyst, for example sodium, potassium or ammonium peroxodisulfate, at pressures of from 7 to 71 kg/cm² and at temperatures of from 0 to 200° C., preferably at temperatures of from 20 to 100° C. (For further details see e.g. U.S. Pat. No. 2,393,967.) Depending on the form in which they are used, the density of these materials can be from 1.2 to 2.3 g/cm³, and the mean particle size can be from 0.05 to 1000 μm.

The fluorinated polyolefins that are preferred according to the invention have mean particle diameters of from 0.05 to 20 μm, preferably from 0.08 to 10 μm, and density of from 1.2 to 1.9 g/cm³.

Suitable fluorinated polyolefins F which can be used in powder form are tetrafluoroethylene polymers having mean particle diameters of from 100 to 1000 μm and densities of from 2.0 g/cm³ to 2.3 g/cm³. Suitable tetrafluoroethylene polymer powders are commercial products and are supplied, for example, by DuPont under the trade name Teflon®.

As well as comprising optional further additives, particularly preferred flame-retardant compositions comprise as component F a fluorinated polyolefin in an amount of from 0.05 to 5.0 parts by weight, preferably from 0.1 to 2.0 parts by weight, particularly preferably from 0.1 to 1.0 part by weight.

The examples which follow serve to explain the invention further.

### Component A

Linear polycarbonate based on bisphenol A with a weight-average molecular weight M̅_{w} of 27,500 g/mol (determined by GPC in dichloromethane with polycarbonate as standard).

### Component B1

ABS graft polymer prepared by emulsion polymerisation of 43 wt. %, based on the ABS polymer, of a mixture of 27 wt. % acrylonitrile and 73 wt. % styrene in the presence of 57 wt. %, based on the ABS polymer, of a particulate crosslinked polybutadiene rubber (mean particle diameter d₅₀=0.35 μm).

### Component B2

n-Butyl-acrylate-modified graft polymer of the ABS type prepared by the mass polymerisation process with an A:B:S ratio of 21:10:65 wt. % and with an n-butyl acrylate content of 4 wt. %. The d₅₀ value of the graft particle diameters, determined by ultracentrifugation, is 0.5 μm. The graft base underlying the graft polymer is a styrene-butadiene block copolymer rubber (SBR). The gel content of the graft polymer, measured in acetone, is 20 wt. %. The weight-average molecular weight M_{w}, measured by GPC in dimethylformamide at 20° C. with polystyrene as standard, of the free n-butyl-acrylate-modified SAN, that is to say the SAN that is not chemically bonded to the rubber or included in the rubber particles in a form insoluble for acetone, is 110 kg/mol.

### Component C

Phenoxyphosphazene of formula (XI) having a content of oligomers with k=1 of 70 mol %, a content of oligomers with k=2 of 18 mol % and a content of oligomers with k≧3 of 12 mol %.

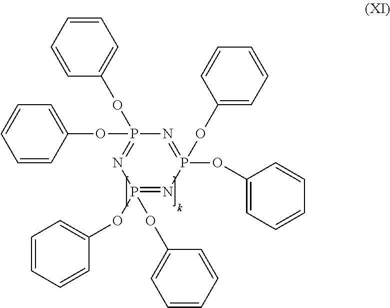

### Component E1

Pentaerythritol tetrastearate as lubricant/demoulding agent.

### Component E2

Heat stabiliser, Irganox® B900 (mixture of 80% Irgafos® 168 and 20% Irganox® 1076; BASF AG; Ludwigshafen/Irgafos® 168 (tris(2,4-di-tert-butyl-phenyl)phosphite)/Irganox® 1076 (2,6-di-tert-butyl-4-(octadecanoxycarbonylethyl)phenol).

### Component F

Polytetrafluoroethylene powder, CFP 6000 N, Du Pont

### Preparation and Testing of the Moulding Compositions

The substances listed in Table 1 are compounded at a speed of 225 rpm and with a throughput of 20 kg/h, at a machine temperature of 260° C., on a twin-screw extruder (ZSK-25) (Werner and Pfleiderer) and granulated.

The finished granules are processed on an injection-moulding machine to the corresponding test specimens (melt temperature 240° C., tool temperature 80° C., flow front speed 240 mm/s).

In order to characterise the properties of the materials, the following methods were used:

The IZOD notched impact strength was measured in accordance with ISO 180/1A on test bars of dimensions 80 mm×10 mm×4 mm overmoulded on one side.

The tensile modulus of elasticity was determined in accordance with ISO 527 on shouldered test bars measuring 170 mm×10 mm×4 mm.

The heat distortion resistance was measured in accordance with ISO 306 (Vicat softening temperature, method B with 50 N load and a heating rate of 120 K/h) on test bars of dimensions 80 mm×10 mm×4 mm overmoulded on one side.

The flowability was determined in accordance with ISO 11443 (melt viscosity).

The melt flowability was evaluated on the basis of the melt volume-flow rate (MVR) measured in accordance with ISO 1133 at a temperature of 260° C. and with a die load of 5 kg.

As a measure of the hydrolytic stability of the prepared compositions there was used the change in the MVR measured in accordance with ISO 1133 at 260° C. with a die load of 5 kg on storage of the granules for 7 days at 95° C. and 100% relative humidity (“FWL storage”). The increase in the MVR value compared with the MVR value prior to corresponding storage was calculated as ΔMVR(hydr.), which is defined by the following formula:

$$Δ MVR ( hydr . ) = \frac{MVR ( after FWL storage ) - MVR ( prior to storage )}{MVR ( prior to storage )} \cdot 100 \%$$

The behaviour in fire was measured in accordance with UL 94V on bars measuring 127×12.7×1.5 mm.

It is clear from Table 1 that the compositions of Examples 1, 2 and 3 with 100%-58% ABS prepared by the mass polymerisation process, based on the total amount of ABS, achieve the object according to the invention, that is to say have a combination of good notched impact strength, temperature stability, modulus of elasticity, flowability (<300 Pas at 1000 s⁻¹) and hydrolytic stability (<50% deviation from the starting value of the MVR 260° C./5 kg after storage for 7d/95° C./100% rel. humidity), with a UL94V-0 classification at 1.5 mm

TABLE 1
Composition and properties of the moulding compositions

| | Unit | 1 | 2 | 3 | 4 (comp.) | 5 (comp.) | 6 (comp.) |
|---|---|---|---|---|---|---|---|
| Components | | | | | | | |
| Component A | wt. % | 79.1 | 79.1 | 79.1 | 79.1 | 79.1 | 79.1 |
| Component B2 | wt. % | 10.0 | 7.4 | 5.8 | 4.2 | 2.6 | |
| Component B1 | wt. % | | 2.6 | 4.2 | 5.8 | 7.4 | 10.0 |
| Component C | wt. % | 10.0 | 10.0 | 10.0 | 10.0 | 10.0 | 10.0 |
| Component E1 | wt. % | 0.4 | 0.4 | 0.4 | 0.4 | 0.4 | 0.4 |
| Component E2 | wt. % | 0.1 | 0.1 | 0.1 | 0.1 | 0.1 | 0.1 |
| Component F | wt. % | 0.4 | 0.4 | 0.4 | 0.4 | 0.4 | 0.4 |
| Properties | | | | | | | |
| Izod notched impact strength/RT (ISO 180/1A) | kJ/m² | 48 | 55 | 63 | 63 | 61 | 59 |
| Tensile modulus of elasticity (ISO 527) | N/mm² | 2506 | 2432 | 2362 | 2298 | 2236 | 2131 |
| Vicat B 120 (ISO 306) | ° C. | 117 | 117 | 116 | 115 | 114 | 115 |
| Melt viscosity 260° C. [100 s−1] (ISO 11443) | Pas | 632 | 698 | 741 | 765 | 787 | 886 |
| Melt viscosity 260° C. [1000 s−1] (ISO 11443) | Pas | 230 | 260 | 280 | 306 | 342 | 390 |
| Melt viscosity 260° C. [1500 s−1] (ISO 11443) | Pas | 182 | 205 | 220 | 242 | 269 | 306 |
| MVR 260° C./5 kg (ISO 1133) | cm³/10 min | 28 | 26 | 23 | 22 | 20 | 16 |
| MVR 260° C./5 kg (ISO 1133) after storage for | cm³/10 min | 31 | 31 | 31 | 34 | 37 | 37 |
| 7 d/95° C./100% rel. humidity | | | | | | | |
| Deviation from the starting value of the MVR | % | 11 | 19 | 35 | 55 | 85 | 131 |
| 260° C./5 kg (ISO 1133) after storage for | | | | | | | |
| 7 d/95° C./100% rel. humidity | | | | | | | |
| UL 94 V 1.5 mm rating | | V-0 | V-0 | V-0 | V-0 | V-0 | V-0 |
| UL 94 V 1.5 mm total afterburning time | s | 10 | 10 | 11 | 11 | 10 | 12 |

1. Composition comprising
A) from 55 to 95 parts by weight of aromatic polycarbonate and/or aromatic polyester carbonate,
B) from 1.0 to 20.0 parts by weight of rubber-modified graft polymer comprising
B1) optionally at least one graft polymer prepared by the emulsion polymerisation process, and
B2) at least one graft polymer prepared by the mass, suspension or solution polymerisation process,
wherein B2) is present in an amount of at least 50 wt. %, based on component B,
C) from 1.0 to 20.0 parts by weight of at least one cyclic phosphazene according to formula (X) 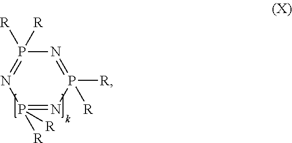
wherein
k represents 1 or an integer from 1 to 10, optionally a number from 1 to 8, optionally from 1 to 5,
wherein the trimer content (k=1) is from 60 to 98 mol %, based on component C,
and wherein
R
is in each case identical or different and represents an amine radical; C₁- to C₈-alkyl, optionally methyl, ethyl, propyl or butyl, each optionally halogenated, optionally halogenated with fluorine; C₁- to C₈-alkoxy, optionally methoxy, ethoxy, propoxy or butoxy; C₅- to C₆-cycloalkyl each optionally substituted by alkyl, optionally C₁-C₄-alkyl, and/or by halogen, optionally chlorine and/or bromine; C₆- to C₂₀-aryloxy, optionally phenoxy, naphthyloxy, each optionally substituted by alkyl, optionally C₁-C₄-alkyl, and/or by halogen, optionally chlorine, bromine, and/or by hydroxy; C₇- to C₁₂-aralkyl, optionally phenyl-C₁-C₄-alkyl, each optionally substituted by alkyl, optionally C₁-C₄-alkyl, and/or by halogen, optionally chlorine and/or bromine; or a halogen radical, optionally chlorine; or an OH radical,
D) from 0 to 15.0 parts by weight of rubber-free vinyl (co)polymer or polyalkylene terephthalate,
E) from 0 to 15.0 parts by weight of one or more additives,
F) from 0.05 to 5.0 parts by weight of one or more antidripping agents,
wherein all the parts by weight are optionally so normalised that the sum of the parts by weight of all the components A+B+C+D+E+F in the composition is 100.

2. Compositions according to claim 1, wherein the content of trimers (k=1) is from 60 to 98 mol %, optionally from 65 to 95 mol %, optionally from 65 to 90 mol %, based on component C.

3. Composition according to claim 1, wherein the amount of component C is from 8.5 to 12.0 parts by weight.

4. Composition according to claim 1, wherein component C is selected from the group consisting of propoxyphosphazenes, phenoxyphosphazenes, methylphenoxyphosphazenes, aminophosphazenes and fluoroalkylphosphazenes.

5. Compositions according to claim 1, wherein R is phenoxy.

6. Composition according to claim 1, wherein the content of trimers (k=1) is from 65 to 85 mol %, based on component C.

7. Composition according to claim 1, wherein the trimer content (k=1) is from 65 to 85 mol %, the tetramer content (k=2) is from 10 to 20 mol %, the content of higher oligomeric phosphazenes (k=3, 4, 5, 6 and 7) is from 5 to 15 mol %, and the content of phosphazene oligomers with k>=8 is from 0 to 1 mol %, in each case based on component C.

8. Composition according to claim 1, wherein component D) is present in an amount of from 2.0 to 12.5 parts by weight.

9. Composition according to claim 1, comprising as component E at least one additive selected from the group consisting of flame-retardant synergists, antidripping agents, lubricants and demoulding agents, nucleating agents, stabilisers, antistatics, colourants, pigments and fillers and reinforcing materials.

10. Composition according to claim 1, wherein component B comprises
B1 in an amount of from 10 to 45 wt. %; and
B2 in an amount of from 55 to 90 wt. %, in each case based on component B.

11. Composition according to claim 1, wherein component B comprises
B1 in an amount of from 10 to 30 wt. %; and
B2 in an amount of from 70 to 90 wt. %, in each case based on component B.

12. Compositions according to claim 1, wherein the graft base of component B1 is selected from the group consisting of diene rubbers, EP(D)M rubbers, acrylate, polyurethane, silicone, chloroprene and ethylene/vinyl acetate rubbers.

13. A cyclic phosphazene according to formula (X) 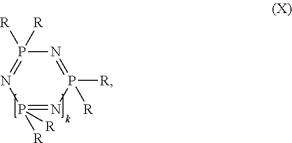
Capable of being used in production of a flame-retardant polymer composition having a property combination of good notched impact strength, temperature stability, modulus of elasticity, flowability and hydrolytic stability while having consistently good UL94V0 classification at 1.5 mm,
wherein
k represents 1 or an integer from 1 to 10, optionally a number from 1 to 8, optionally from 1 to 5,
wherein the trimer content (k=1) is from 60 to 98 mol %, based on component C,
and wherein
R
is in each case identical or different and represents an amine radical; C₁- to C₈-alkyl, optionally methyl, ethyl, propyl or butyl, each optionally halogenated, optionally halogenated with fluorine; C₁- to C₈-alkoxy, optionally methoxy, ethoxy, propoxy or butoxy; C₅- to C₆-cycloalkyl each optionally substituted by alkyl, optionally C₁-C₄-alkyl, and/or by halogen, optionally chlorine and/or bromine; C₆- to C₂₀-aryloxy, optionally phenoxy, naphthyloxy, each optionally substituted by alkyl, optionally C₁-C₄-alkyl, and/or by halogen, optionally chlorine, bromine, and/or by hydroxy; C₇- to C₁₂-aralkyl, optionally phenyl-C₁-C₄-alkyl, each optionally substituted by alkyl, optionally C₁-C₄-alkyl, and/or by halogen, optionally chlorine and/or bromine; or a halogen radical, optionally chlorine; or an OH radical.

14. A composition according to claim 1 capable of being used in production of injection-moulded and/or thermoformed moulded articles.

15. Moulded article obtainable from a composition according to claim 1.
